(19) United States
(12) Patent Application Publication
(10) Pub. No.: US 2014/0040759 A1
(43) Pub. Date: Feb. 6, 2014

(54) USER INTERFACE (UI) CREATION SUPPORT SYSTEM, UI CREATION SUPPORT METHOD AND NON-TRANSITORY STORAGE MEDIUM

(71) Applicants: Ryosuke Okubo, Tokyo (JP); Shunsuke Suzuki, Tokyo (JP); Yukiko Tanikawa, Tokyo (JP)

(72) Inventors: Ryosuke Okubo, Tokyo (JP); Shunsuke Suzuki, Tokyo (JP); Yukiko Tanikawa, Tokyo (JP)

(73) Assignee: NEC CORPORATION, Tokyo (JP)

(21) Appl. No.: 14/112,196

(22) PCT Filed: Apr. 4, 2012
(86) PCT No.: PCT/JP2012/002347

§ 371 Date: Oct. 16, 2013

(30) Foreign Application Priority Data
Apr. 19, 2011 (JP) 2011-092906

(51) Int. Cl. G06F 3/048

(52) U.S. Cl. CPC G06F 3/048
USPC 715/744

(57) ABSTRACT

There is provided a UI creation support system (1) that provides support for creating a user interface (UI) screen used for a certain job for each user, the UI creation support system includes: an acquisition unit (10) that acquires job familiarity information, which indicates a level of familiarity with the job, and device familiarity information, which indicates a level of familiarity with a device used for operating the UI screen; a prioritization unit (20) that determines which one of the job familiarity information and the device familiarity information is to be set as a prior configuration content for each of a plurality of configuration items into which a configuration of the UI screen is finely divided; and a UI configuration determination unit (40) that determines the configuration content on the basis of the job familiarity information or the device familiarity information prioritized by the prioritization unit (20) for each of the configuration items.

### TECHNICAL FIELD

The present invention relates to a UI creation support system, a UI creation support method, and a program.

### BACKGROUND ART

It is necessary for a user (hereinafter, a “design user”), who creates a UI screen, to figure out a user (hereinafter, a “supposed user”), who uses the created UI screen, and design a UI screen appropriate for the supposed user. However, it is not easy to design the UI screen appropriate for the supposed user.

Patent Document 1 describes a screen transition control method that determines the degree of proficiency in the input operation of the supposed user on the basis of the duration of use, the number of times of use, and the operation time of a terminal device of the supposed user so as to omit the input instruction screen on the basis of the determination result. Specifically, in the description, at a stage in which the supposed user is unfamiliar with an order job, transition from the menu screen to the input instruction screen for all stages to reach the data registration completion screen is made, and when the supposed user is familiar with the order job, the data list screen is omitted from the menu screen, transition to the data input screen is made, thereafter the data registration completion screen and the like are omitted, and transition to the menu screen occurs again.

### RELATED DOCUMENT

### Patent Document

[Patent Document 1] Japanese Unexamined Patent Publication No. 08-137649

### DISCLOSURE OF THE INVENTION

When a UI screen used for a certain job is designed, the UI screen appropriate for the supposed user is different in accordance with familiarity with the job of the supposed user (hereinafter, “job familiarity”) and familiarity with the device used to operate the UI screen (hereinafter, “device familiarity”). The inventors of the present invention studied for a unit that creates the UI screen appropriate for the supposed user in consideration of the job familiarity and the device familiarity of the supposed user, and consequently found the following problem in the related art.

The essential configuration of the UI screen for the supposed user with high job familiarity tends to be the same as the essential configuration of the UI screen for the supposed user with high device familiarity. For example, on the UI screens for such users, a plurality of processes is performed in parallel, and thus it is possible to adopt a configuration in which multiple windows can be used simultaneously. Further, the essential configuration of the UI screen for the supposed user with low job familiarity also tends to be the same as the essential configuration of the UI screen for the supposed user with low device familiarity. For example, on the UI screens for such users, a plurality of processes is inhibited from being performed in parallel, and thus it is possible to adopt a configuration in which only a single window can be used during a single operation.

However, the job familiarity and the device familiarity of the supposed user are not always at the same level, and the one familiarity may be high but the other familiarity may be low. Conventionally, there is no technique for creating an appropriate UI screen in consideration of the situation. Since the technique described in Patent Document 1 does not consider the above-mentioned point, a UI screen appropriate for the supposed user whose one familiarity is high but the other familiarity is low cannot be created.

An object of the present invention is to provide a technique for creating the UI screen in which the job familiarity and the device familiarity of the supposed user with levels, which are not always the same, are appropriately reflected and which is appropriate for the supposed user.

According to the present invention, there is provided a UI creation support system that provides support for creating a user interface (UI) screen used for a certain job for each user, the UI creation support system includes: an acquisition unit that acquires job familiarity information, which indicates a level of familiarity with the job, and device familiarity information, which indicates a level of familiarity with a device used for operating the UI screen; a prioritization unit that determines which one of the job familiarity information and the device familiarity information is to be set as a prior configuration content for each of a plurality of configuration items into which a configuration of the UI screen is finely divided; and a UI configuration determination unit that determines the configuration content on the basis of the job familiarity information or the device familiarity information prioritized by the prioritization unit for each of the configuration items.

Further, according to the present invention, there is provided a program that provides support for creating a user interface (UI) screen used for a certain job for each user, the program that causes a computer to execute functions of: an acquisition unit that acquires job familiarity information, which indicates a level of familiarity with the job, and device familiarity information, which indicates a level of familiarity with a device used for operating the UI screen; a prioritization unit that determines which one of the job familiarity information and the device familiarity information is to be set as a prior configuration content for each of a plurality of configuration items into which a configuration of the UI screen is finely divided; and a UI configuration determination unit that determines the configuration content on the basis of the job familiarity information or the device familiarity information prioritized by the prioritization unit for each of the configuration items.

Furthermore, according to the present invention, there is provided a UI creation support method of providing support for creating a user interface (UI) screen used for a certain job for each user, the UI creation support method includes: an acquisition step of acquiring job familiarity information, which indicates a level of familiarity with the job, and device familiarity information, which indicates a level of familiarity with a device used for operating the UI screen; a prioritization step of determining which one of the job familiarity information and the device familiarity information is to be set as a prior configuration content for each of a plurality of configuration items into which a configuration of the UI screen is finely divided; and a UI configuration determination step of determining the configuration content on the basis of the job familiarity information or the device familiarity information prioritized by the prioritization step for each of the configuration items.

According to the present invention, it is possible to create the UI screen in which the job familiarity and the device familiarity of the supposed user with levels, which are not always the same, are appropriately reflected and which is appropriate for the supposed user.

### BRIEF DESCRIPTION OF THE DRAWINGS

The above-mentioned object, other objects, characteristics, and advantages are further clarified by the preferred embodiments to be described later and the following drawings appended thereto.

FIG. 1 shows an example of a function block diagram of a UI creation support system of the present embodiment.

FIG. 2 shows an example of information which is held by the configuration holding unit of the present embodiment.

FIG. 3 shows an example of information which is held by the weight holding unit of the present embodiment.

FIG. 4 is a flowchart showing an example of the processing flow of the UI creation support method of the present embodiment.

FIG. 5 is a flowchart showing an example of the processing flow of the UI creation support method of the present embodiment.

### DESCRIPTION OF EMBODIMENTS

Hereinafter, the embodiments of the present invention will be described with reference to the drawings.

It should be noted that the respective units of the present embodiment are implemented by a CPU of an arbitrary computer, a memory, programs (including not only programs, which are stored in the memory in advance since when the apparatus is shipped, but also programs which are downloaded from a storage medium such as a CD and a server on the Internet) loaded on the memory, a storage unit such as a hard disk which stores the program, and arbitrary combination of hardware and software centering on an interface for network connection. In addition, it should be understood by those skilled in the art that there are various modified examples of the implementation method and the device.

Further, the function block diagram used in the description of the present embodiment does not show a configuration of hardware units but blocks of function units. In such a diagram, each device of the present embodiment is implemented by a single apparatus, but the implemented device is not limited to this. That is, the device may be configured to be physically divided or may be configured to be logically divided.

First, a brief overview of the present embodiment will be described.

The UI creation support system of the present embodiment provides support for creating a UI screen, which is used for a certain job, for each user, and thus performs the following processes of (1) to (3).

(1) The system receives, from a design user who creates the UI screen, the respective inputs of information (hereinafter, “job familiarity information”), which indicates a job familiarity of a supposed user to use the UI screen being designed, and information (hereinafter, “device familiarity information”) which indicates a device familiarity. The job familiarity information and the device familiarity information are set as values indicating the levels thereof like for example, “Lv1”, “Lv2”, “Lv3”, . . . , and so forth.

(2) The system determines which one of the job familiarity information and the device familiarity information is to be set as a prior configuration content for each of a plurality of configuration items into which a configuration of the UI screen is finely divided. As the configuration items, for example “a degree of freedom of the execution unit” and the like can be considered. As the specific configuration contents of the configuration item, the followings can be considered: “execution is made possible only by using a mouse or touch”; “a shortcut key is provided”; “a shortcut key is provided or an operation only on a keyboard is optimized”; and the like.

(3) The system determines the configuration content, on the basis of the job familiarity information or the device familiarity information, which is prioritized in (2), for each of the configuration items.

As described above, the UI creation support system of the present embodiment determines which one of the job familiarity information and the device familiarity information is to be set as a prior configuration content for each of the plurality of configuration items into which the configuration of the UI screen is finely divided. Then, the system determines the configuration content of the UI screen for each configuration item on the basis of the determined familiarity information, and thereby determines the configuration of the single UI screen on the basis of the combination of them.

Next, the configuration of the present embodiment will be described in detail.

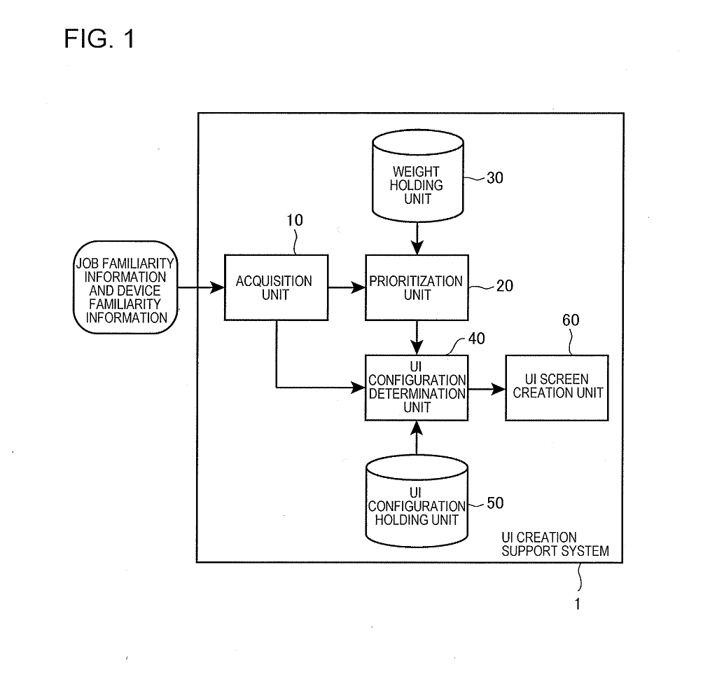

FIG. 1 shows a function block diagram illustrating an example of the configuration of the UI creation support system 1 of the present embodiment. The UI creation support system 1 of the present embodiment has an acquisition unit 10, a prioritization unit 20, and a UI configuration determination unit 40. Further, the UI creation support system 1 of the present embodiment may have at least one of a weight holding unit 30, a UI configuration holding unit 50, and a UI screen creation unit 60. Hereinafter, the respective units will be described.

The acquisition unit 10 acquires the job familiarity information and the device familiarity information. The job familiarity and the device familiarity are divided in advance into a predetermined number (design factor) of levels such as “Lv1”, “Lv2”, “Lv3”, . . . , or “advanced”, “intermediate”, and “beginner”, and thus the acquisition unit 10 holds the information. In addition, the acquisition unit 10 receives the input of the level for each of the job familiarity and the device familiarity, from the design user, through all input devices such as a mouse, a keyboard, a touch panel display, and a microphone. The input may be made by using the UI screen having the graphical user interface (GUI) components such as a check box and a drop-down list. It should be noted that the job familiarity and the device familiarity are divided into the levels by the same means (the number of levels or the like). In the present embodiment, either one of the job familiarity and the device familiarity is divided into three levels of “Lv1”, “Lv2”, and “Lv3”. The “Lv1” is the lowest level of the familiarity, the “Lv3” is the highest level of the familiarity, and the “Lv2” is the intermediate level between the “Lv1” and the “Lv3”.

The prioritization unit 20 determines which one of the job familiarity information and the device familiarity information is to be set as a prior configuration content for each of the plurality of configuration items into which the configuration of the UI screen is finely divided.

First, the configuration items will be described. As a specific example of the configuration item, for example, “input unit of data on the UI screen” is considered. As specific configuration contents of the configuration item, a mouse input, a keyboard input, combination of the mouse input and the keyboard input, a voice input from the microphone, and the like are considered. It should be noted that the unit that finely divides the configuration of the UI screen into the plurality of configuration items, specifically, the number of the configuration items, the contents of the configuration items, and the like are not particularly limited, but there may be more variations of the UI screen which can be created when the configuration is more finely divided.

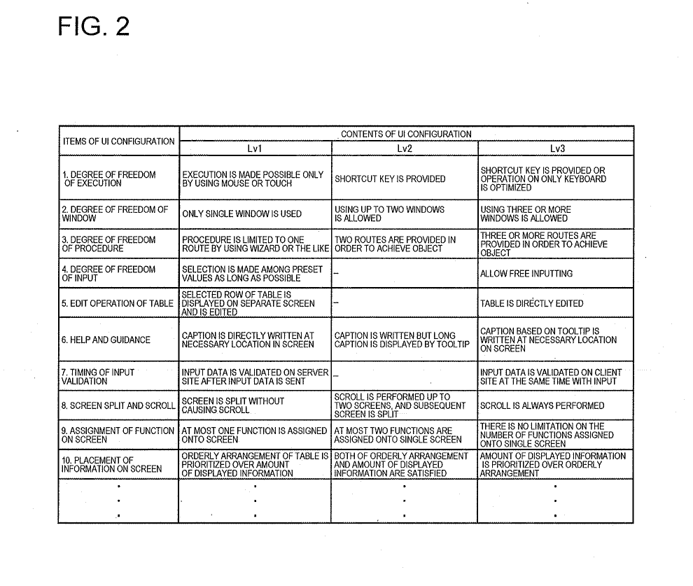

Here, FIG. 2 shows a specific example of the configuration items and an example of the specific configuration contents of each configuration item. The information shown in FIG. 2 is held by the UI configuration holding unit 50 shown in FIG. 1.

In FIG. 2, the configuration items are written in the field of “the items of the UI configuration”, and the specific configuration contents of each configuration item are written in the field of “the contents of the UI configuration”. It should be noted that the field of “the contents of the UI configuration” can be divided into three fields of “Lv1”, “Lv2”, and “Lv3” corresponding to the levels of the job familiarity and the device familiarity, and the configuration content, which is appropriate for the UI screen for the supposed user with the familiarity of the level, is written for each level. That is, the information shown in FIG. 2 is information in which the appropriate configuration contents corresponding to the levels (familiarities) are set for each configuration item.

For example, in the case of the data shown in FIG. 2, “the degree of freedom of the execution unit” as the configuration item is included. The configuration item relates to a configuration for executing a predetermined function on the UI screen. In addition, as the configuration contents of the configuration item, the followings are written: “execution is made possible only by using a mouse or touch” corresponding to the familiarity “Lv1”; “a shortcut key is provided” corresponding to the familiarity “Lv2”; and “a shortcut key is provided or an operation only on a keyboard is optimized” corresponding to the familiarity “Lv3”. It should be noted that the configuration items shown in FIG. 2 and the configuration contents of each configuration item are just an example, and among all other configuration contents which can be implemented by using a conventional technique, various contents can be selected in consideration of a situation of the use of the UI screen to be designed, a usage scene, a budget, and the like. Further, as shown in FIG. 2, in all the configuration items, it is not always necessary to write the configuration contents corresponding to all the respective levels (familiarities). For example, in the configuration item “the degree of freedom of the input”, the configuration contents corresponding to the familiarities “Lv1” and “Lv3” are written, but the configuration content corresponding to the familiarity “Lv2” is not written.

It should be noted that the information shown in FIG. 2 is a common content for the job familiarity and the device familiarity. That is, the essential configuration of the UI screen for the supposed user whose job familiarity is “Lv1” is the same as the essential configuration of the UI screen for the supposed user whose device familiarity is “Lv1”, the essential configuration of the UI screen for the supposed user whose job familiarity is “Lv2” is the same as the essential configuration of the UI screen for the supposed user whose device familiarity is “Lv2”, and the essential configuration of the UI screen for the supposed user whose job familiarity is “Lv3” is the same as the essential configuration of the UI screen for the supposed user whose device familiarity is “Lv3”. However, the example is just an example, and the appropriate configuration contents corresponding to the respective levels (familiarities) may be set for each of the job familiarity and the device familiarity.

Next, the prioritization unit 20 as a unit that determines which one of the job familiarity information and the device familiarity information to set as the prior configuration content for each configuration item will be described. It should be noted that multiple variations of the unit can be considered, and an example is hereinafter described.

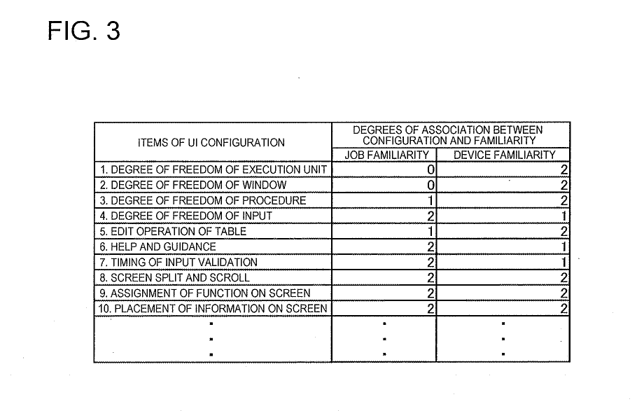

In the case of the present example, the prioritization unit 20 uses the job familiarity information and the device familiarity information which are acquired by the acquisition unit 10, the information shown in FIG. 3, and the following expression (Numerical Expression 1).

Priority=Familiarity Constant×Degree of Association between Configuration and Familiarity [Numerical Expression 1]

The information shown in FIG. 3 is held by the weight holding unit 30 shown in FIG. 1. The information indicates respective weight values (degrees of association between the configuration and the familiarity) of the job familiarity and the device familiarity which are set for each configuration item. The values correspond to “degrees of association between the configuration and the familiarity” shown in the expression (Numerical Expression 1). It should be noted that the weight values shown in FIG. 3 are given in view of the following points.

(1) The weight value indicates the degree of importance which is used when the specific configuration content of each configuration item is determined.

(2) The weight value is set to be larger as the degree of importance, which is used when the specific configuration content of each configuration item is determined, is higher.

(3) If it is not necessary to give importance when determining the specific configuration content of each configuration item, a value reflecting the effect thereof is set as the familiarity. In the example of the drawing, “0” is set. It is assumed that, in a certain configuration item, neither one of the job familiarity nor the device familiarity is set at “0” contrary to the drawing.

It should be noted that the weight holding unit 30 of the present embodiment holds the information shown in FIG. 3, but this description is just an example.

Further, the prioritization unit 20 holds constants (familiarity constants), which are respectively given to familiarities divided into predetermined numbers (design factor) of levels, in advance. In the present embodiment, the prioritization unit 20 holds a familiarity constant “7” at the familiarity “Lv1”, a familiarity constant “3” at the familiarity “Lv2”, and a familiarity constant “1” at the familiarity “Lv3”. Each familiarity constant is just an example. The familiarity constant corresponds to the “familiarity constant” shown in the expression (Numerical Expression 1). It should be noted that the familiarity constants are given in view of the following points.

(1) The familiarity constant indicates the degree of importance which is used when the specific configuration content of each configuration item is determined.

(2) The familiarity constant is set to be larger as the degree of importance, which is used when the specific configuration content of each configuration item is determined, is higher. In the case of the above example, the larger familiarity constant is given to the lower familiarity. In such a manner, when the levels of the job familiarity and the device familiarity of the supposed user do not coincide, the UI screen for the lower familiarity tends to be created.

An example of the process, which is performed by the prioritization unit 20 on the basis of such information, is as follows. First, the prioritization unit 20 determines the respective familiarity constants of the job familiarity and the device familiarity, on the basis of the job familiarity information and the device familiarity information which are acquired by the acquisition unit 10. Subsequently, the prioritization unit 20 calculates the respective priorities of the job familiarity and the device familiarity, on the basis of the expression (Numerical Expression 1), for each configuration item by using the familiarity constants and the information which is held by the weight holding unit 30 as shown in FIG. 3. Then, the prioritization unit 20 compares the magnitudes of the respective priorities of the job familiarity and the device familiarity for each configuration item, gives priority to the familiarity with a larger value for each configuration item, and determines to set the configuration contents. Consequently, the determination is made to set the configuration contents on the basis of the familiarity information (the job familiarity information or the device familiarity information) with high priority familiarity.

Returning to FIG. 1, the UI configuration determination unit 40 determines the configuration content, on the basis of the job familiarity information or the device familiarity information which is prioritized by the prioritization unit 20, for each configuration item. For example, the UI configuration determination unit 40 determines the configuration content for each configuration item by using the information which is held by the UI configuration holding unit 50 and is shown in FIG. 2. That is, the UI configuration determination unit 40 searches the configuration content corresponding to the level of the familiarity (in the case of the present embodiment, “Lv1”, “Lv2”, or “Lv3”) which is specified by the job familiarity information or the device familiarity information which is prioritized by the prioritization unit 20, for each configuration item, and determines the configuration content, which is acquired as the search result, as a configuration content of the configuration item.

The UI screen creation unit 60 creates the UI screen in accordance with the determination of the UI configuration determination unit 40. Such configuration of the UI screen creation unit 60 can be realized through the conventional art. For example, the modules, which respectively implements the configuration contents (for example: “execution is made possible only by using a mouse or touch”) shown in FIG. 2, are stored in a storage device in advance, and the UI screen creation unit 60 may create a single UI screen by using the respective modules of the configuration contents determined for each configuration item, the combination thereof, and the like.

The UI creation support system of the present embodiment is implemented by installing for example the following program in a computer.

A program that provides support for creating a user interface (UI) screen used for a certain job for each user, the program that causes a computer to execute functions of:

an acquisition unit that acquires job familiarity information, which indicates a level of familiarity with the job, and device familiarity information, which indicates a level of familiarity with a device used for operating the UI screen;

a prioritization unit that determines which one of the job familiarity information and the device familiarity information is to be set as a prior configuration content for each of a plurality of configuration items into which a configuration of the UI screen is finely divided; and

a UI configuration determination unit that determines the configuration content on the basis of the job familiarity information or the device familiarity information prioritized by the prioritization unit for each of the configuration items.

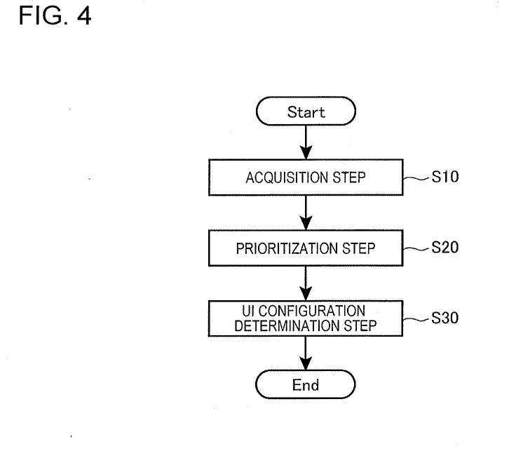

Next, by using the flowchart shown in FIG. 4, an example of the UI creation support method of the present embodiment will be described.

First, the acquisition unit 10 acquires the job familiarity information that indicates the familiarity of the job and the device familiarity information that indicates the familiarity of the device used to operate the UI screen (S10: acquisition step). In the present embodiment, the acquisition unit 10 acquires any one of the familiarities “Lv1” to “Lv3” as each, of the job familiarity information and the device familiarity information. Here, the familiarity “Lv2” is acquired as the job familiarity information, and the familiarity “Lv3” is acquired as the device familiarity information.

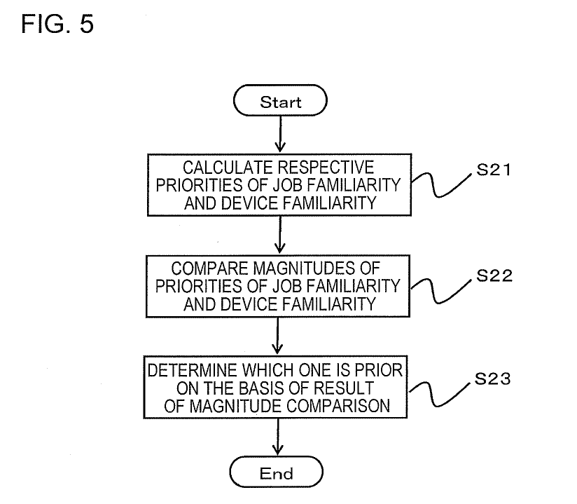

Next, the prioritization unit 20 determines which one of the job familiarity information and the device familiarity information is to be set as a prior configuration content for each of the plurality of configuration items into which the configuration of the UI screen is finely divided (S20: prioritization step). Here, in the case of the example of “the degree of freedom of the execution unit” and “the degree of freedom of the input” among the plurality of configuration items shown in FIG. 2, an example of a process will be described with reference to the flowchart of FIG. 5.

First, the process for the configuration item “the degree of freedom of the execution unit” will be described. The prioritization unit 20 calculates the respective priorities of the job familiarity and the device familiarity, by using the information which is held by the weight holding unit 30 and shown in FIG. 3, the familiarity constants (a familiarity constant “7” at the familiarity “Lv1”, a familiarity constant “3” at the familiarity “Lv2”, and a familiarity constant “1” at the familiarity “Lv3”) which are held in advance, and the expression (Numerical Expression 1) (S21). Here, the priority “0” (=3×0) of the job familiarity and the priority “2” (=1×2) of the device familiarity are calculated. Thereafter, the prioritization unit 20 compares the magnitudes of the priorities (S22), gives priority to the device familiarity information with a larger value, and determines to set the configuration contents of the configuration item “the degree of freedom of the execution unit” (S23).

Next, the process for the configuration item “the degree of freedom of the input” will be described. The prioritization unit 20 calculates, in a similar manner, the respective priorities of the job familiarity and the device familiarity, by using the information which is held by the weight holding unit 30 and shown in FIG. 3, the familiarity constants (a familiarity constant “7” at the familiarity “Lv1”, a familiarity constant “3” at the familiarity “Lv2”, and a familiarity constant “1” at the familiarity “Lv3”), and the expression (Numerical Expression 1) (S21). Here, the priority “6” (=3×2) of the job familiarity and the priority “1” (=1×1) of the device familiarity are calculated. Thereafter, the prioritization unit 20 compares the magnitudes of the priorities (S22), gives priority to the device familiarity information with a larger value, and determines to set the configuration contents of the configuration item “the degree of freedom of the input” (S23).

By executing the above-mentioned process, the prioritization unit 20 determines which one of the job familiarity information and the device familiarity information to preferentially set as a configuration content.

Subsequently, the UI configuration determination unit 40 determines the configuration content, on the basis of the job familiarity information or the device familiarity information which is prioritized by the prioritization unit 20 in S20, for each configuration item (S30: UI configuration determination step). Here, also in the case of the example of “the degree of freedom of the execution unit” and “the degree of freedom of the input” among the plurality of configuration items shown in FIG. 2, the process will be described.

First, the process for the configuration item “the degree of freedom of the execution unit” will be described. The UI configuration determination unit 40 determines the configuration content, on the basis of the device familiarity information which is prioritized by the prioritization unit 20 in S20, with reference to the information which is held by the UI configuration holding unit 50 and is shown in FIG. 2. Specifically, the UI configuration determination unit 40 determines the configuration content “a shortcut key is provided or an operation only on a keyboard is optimized”, which is associated with the device familiarity information: the familiarity “Lv3” in FIG. 2, as a configuration content of the configuration item “the degree of freedom of the execution unit”.

Next, the process for the configuration item “the degree of freedom of the input” will be described. The UI configuration determination unit 40 determines the configuration content, on the basis of the job familiarity information which is prioritized by the prioritization unit 20 in S20, with reference to the information which is held by the UI configuration holding unit 50 and is shown in FIG. 2. Specifically, the UI configuration determination unit 40 determines the configuration content, which can be associated with the job familiarity information: the familiarity “Lv2” in FIG. 2, as a configuration item “the degree of freedom of the input”, but the configuration content cannot be associated with the familiarity “Lv2” in the information shown in FIG. 2. In such a case, the UI configuration determination unit 40 determines a different configuration content in accordance with the predetermined operation. In the present embodiment, the UI configuration determination unit 40 checks whether the configuration content can be associated while shifting the level of familiarity to the lower side, and determines the configuration content, which is detected first, as a configuration content of the configuration item. Specifically, the UI configuration determination unit 40 determines the configuration content “selection is made among preset values as long as possible”, which can be associated with the familiarity “Lv1”, as a configuration content of the configuration item “the degree of freedom of the input”.

It should be noted that the configuration content determined for each configuration item in S30 is stored in the storage device. Then, for example, the UI screen creation unit 60 creates the UI screen in accordance with the determination content in S30.

Next, the function effect of the present embodiment will be described.

According to the present embodiment, the design user of the UI screen inputs the job familiarity and the device familiarity of the supposed user, who uses the UI screen being designed, to the UI creation support system of the present embodiment, and is able to determine the essential configuration of the UI screen for the supposed user.

Further, according to the present embodiment, even a design user, who has insufficient knowledge about the UI screen, is able to efficiently design an effective UI screen.

Furthermore, it is very troublesome even for a design user, who is good at the knowledge about the UI screen, to examine the configuration contents and determine the content for each configuration item, and it can be considered that the work requires time and effort. According to the present embodiment, for example, first, the first design of the configuration provided in the UI screen being designed is created by using the UI creation support system of the present embodiment, and thereafter the design of the UI screen can be changed on the basis of the first design. It can be said from this point of view that, according to the present embodiment, it is possible to reduce time and effort in designing the UI screen.

In addition, in the present embodiment, it is determined which one of the job familiarity information and the device familiarity information is to set be as a prior configuration for each configuration item by not only using “the degree indicating how much importance is given to which one of the job familiarity and the device familiarity when determining the configuration content (the weight value of FIG. 3)”, which is set in advance for each configuration item, but also using “the familiarity constant capable of reflecting the difference between the job familiarity and the device familiarity of the supposed user into the determination of the configuration content”. According to the present embodiment, it is possible to create the UI screen in which the job familiarity and the device familiarity of the supposed user with levels, which are not always the same, are appropriately reflected and which is appropriate for the supposed user.

This application claims the benefit of priority from the Japanese Patent Application No. 2011-092906 filed on Apr. 19, 2011, and the entire contents of the application are incorporated herein by reference.

1. A UI creation support system that provides support for creating a user interface (UI) screen used for a certain job for each user, the UI creation support system comprising:
an acquisition unit that acquires job familiarity information, which indicates a level of familiarity with the job, and device familiarity information, which indicates a level of familiarity with a device used for operating the UI screen;
a prioritization unit that determines which one of the job familiarity information and the device familiarity information is to be set as a prior configuration content for each of a plurality of configuration items into which a configuration of the UI screen is finely divided; and
a UI configuration determination unit that determines the configuration content on the basis of the job familiarity information or the device familiarity information prioritized by the prioritization unit for each of the configuration items.

2. The UI creation support system according to claim 1,
wherein the prioritization unit determines which one of the job familiarity information and the device familiarity information to set as the prior configuration content by using the job familiarity information and the device familiarity information.

3. The UI creation support system according to claim 2, further comprising:
a weight holding unit that holds respective weight values of the job familiarity information and the device familiarity information which are set for each of the configuration items,
wherein the prioritization unit determines which one of the job familiarity information and the device familiarity information to set as the prior configuration content also by using the weight values.

4. The UI creation support system according to claim 1, further comprising
a UI configuration holding unit that holds information in which configuration contents corresponding to the levels of the job familiarity and the device familiarity are set for each of the configuration items,
wherein the UI configuration determination unit determines the configuration content for each of the configuration items, on the basis of a result of search of the UI configuration holding unit using the job familiarity information or the device familiarity information as a key.

5. The UI creation support system according to claim 1, further comprising
a UI screen creation unit that creates the UI screen in accordance with the determination of the UI configuration determination unit.

6. A non-transitory storage medium storing a program that provides support for creating a user interface (UI) screen used for a certain job for each user, the program that causes a computer to execute functions of:
an acquisition unit that acquires job familiarity information, which indicates a level of familiarity with the job, and device familiarity information, which indicates a level of familiarity with a device used for operating the UI screen;
a prioritization unit that determines which one of the job familiarity information and the device familiarity information is to be set as a prior configuration content for each of a plurality of configuration items into which a configuration of the UI screen is finely divided; and
a UI configuration determination unit that determines the configuration content on the basis of the job familiarity information or the device familiarity information prioritized by the prioritization unit for each of the configuration items.

7. A UI creation support method of providing support for creating a user interface (UI) screen used for a certain job for each user, the UI creation support method comprising:
an acquisition step of acquiring job familiarity information, which indicates a level of familiarity with the job, and device familiarity information, which indicates a level of familiarity with a device used for operating the UI screen;
a prioritization step of determining which one of the job familiarity information and the device familiarity information is to be set as a prior configuration content for each of a plurality of configuration items into which a configuration of the UI screen is finely divided; and
a UI configuration determination step of determining the configuration content on the basis of the job familiarity information or the device familiarity information prioritized by the prioritization step for each of the configuration items.
